(19) United States
(12) Patent Application Publication
(10) Pub. No.: US 2018/0120115 A1
(43) Pub. Date: May 3, 2018

(54) MOBILE-BODY POSITION DETECTING APPARATUS AND MOBILE-BODY POSITION DETECTING METHOD

(71) Applicant: DENSO CORPORATION, Kariya-city, Aichi-pref. (JP)

(72) Inventors: Takeshi SHIKIMACHI, Kariya-city (JP); Kiyoshi TSURUMI, Kariya-city (JP)

(73) Assignee: DENSO CORPORATION, Kariya-city, Aichi-pref. (JP)

(21) Appl. No.: 15/569,856

(22) PCT Filed: Apr. 11, 2016
(86) PCT No.: PCT/JP2016/001969

§ 371 Date: Oct. 27, 2017

(30) Foreign Application Priority Data
May 15, 2015 (JP) 2015-100270
Jan. 28, 2016 (JP) 2016-014211

(51) Int. Cl. G01C 21/30; G01C 21/16; G09B 29/10

(52) U.S. Cl. CPC G01C 21/30; G09B 29/106; G01C 21/165

(57) ABSTRACT

An apparatus of detecting a position of a mobile body acquires a current position based on a result of accumulating heading directions and movement distances of the mobile body, acquires a modified current position acquired from modification by verifying a movement locus of the mobile body with a road shape, and compares the current position with the modified current position, thereby assigning a reliability degree to the modified current position. Alternatively, the apparatus acquires a current position based on a result of accumulating heading directions and movement distances of the mobile body, and compares the current position with a positioning result acquired based positioning satellites, thereby assigning a reliability degree to the current position.

### CROSS REFERENCE TO RELATED APPLICATION

The present disclosure is based on Japanese Patent Application No. 2015-100270 filed on May 15, 2015 and Japanese Patent Application No. 2016-14211 filed on Jan. 28, 2016, the disclosures of which are incorporated herein by reference.

### TECHNICAL FIELD

The present disclosure applies to a mobile body that includes a direction sensor detecting a heading direction, a distance sensor detecting a movement distance, and a reception apparatus receiving positioning signals from positioning satellites; the present disclosure relates to an apparatus and a method of detecting a current position of the mobile body.

### BACKGROUND ART

A recent mobile body such as a vehicle is mounted with a direction sensor such as a gyro sensor and a distance sensor detecting a movement distance of a vehicle such as a vehicle sensor. For instance, if a position and a direction where a host vehicle stops is stored, accumulating the information on heading directions of the host vehicle acquired from the direction sensor and the information on movement distances of the host vehicle acquired from the distance sensor enables the autonomous detection of the current position of the host vehicle. This method of detecting the current position of the host vehicle is referred to as a dead reckoning navigation.

The dead reckoning navigation accumulates errors involved in the direction sensor or the distance sensor when the vehicle moves long distance, thereby causing a gap in the detection result of the current position. There is developed a technology that amends such a gap in the current position caused by the dead reckoning navigation, using a positioning result by GNSS (Global Navigation Satellite System). The GNSS receives positioning signals from several positioning satellites, and thus can measure the current position at certain accuracy.

There is also developed a technology called “map matching” that verifies the information on movement route of a host vehicle acquired using the dead reckoning navigation with the road shape acquired from map information, to thereby amend the position gap due to the accumulated errors (Patent literature 1). This technology, if allowing an accurate detection of the current position of a host vehicle, may achieve an advanced driving assistance such as decelerating the host vehicle at an intersection, for instance.

### PRIOR ART LITERATURES

### Patent Literature

Patent literature 1: JP 4140559 B2

### SUMMARY OF INVENTION

There is, however, an issue that limits a target for driving assistance practically performed based on the detection result of the current position, even when the current position of the host vehicle detected by the dead reckoning navigation is amended using the map matching and the positioning result by GNSS. This is because the positioning result by the GNSS or the detection result of the current position with the map matching still includes an error, requiring a target for driving assistance to be limited to a range where an error included in the current position after the amendment does not pose a big problem.

It is an object of the present disclosure to provide a technology that makes it possible to utilize further a detection result of a current position for driving assistance.

According to a first aspect, a mobile-body position detecting apparatus and a mobile-body position detecting method are provided as follows. Comparison is made between a current position acquired based on a result of accumulating heading directions and movement distances of a mobile body and a current position (modified current position) acquired by verifying a movement locus of the mobile body with a road shape; thereby the modified current position is assigned with the information on reliability degree.

This indicates how much reliability the acquired modified current position provides; the modified current position can be further utilized for driving assistance.

Further, according to a second aspect, a mobile-body position detecting apparatus and a mobile-body position detecting method are provided as follows. Comparison is made between a current position acquired based on a result of accumulating heading directions and movement distances of a mobile body and a positioning result acquired based on positioning signals; thereby the current position is assigned with the information on reliability degree.

This also indicates how much reliability the acquired current position provides; the current position can be further utilized for driving assistance.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating a vehicle 1 mounted with a mobile-body position detecting apparatus according to a first embodiment;

FIG. 2 is a block diagram illustrating an internal configuration of the mobile-body position detecting apparatus according to the first embodiment;

FIG. 3 is a flowchart of a former half of a current position detecting process executed by the mobile-body position detecting apparatus according to the first embodiment;

FIG. 4 is a flowchart of a latter half of the current position detecting process executed by the mobile-body position detecting apparatus according to the first embodiment;

FIG. 5 is a diagram illustrating a mode in which a dead reckoning navigation acquires a current position and a movement locus of a host vehicle;

FIG. 6 is a diagram illustrating a mode in which a map matching modifies a current position;

FIG. 7 is a diagram illustrating a mode in which a position of a host vehicle is assigned with a reliability degree by the mobile-body position detecting apparatus according to the first embodiment;

FIG. 8 is a block diagram illustrating an internal configuration of a mobile-body position detecting apparatus according to a second embodiment;

FIG. 9 is a flowchart of a former half of a current position detecting process executed by the mobile-body position detecting apparatus according to the second embodiment;

FIG. 10 is a flowchart of a latter half of the current position detecting process executed by the mobile-body position detecting apparatus according to the second embodiment;

FIG. 11 is a diagram illustrating a mode in which a current position of a host vehicle is assigned with a reliability degree by the mobile-body position detecting apparatus according to the second embodiment;

FIG. 12 is a diagram illustrating a modification example in which a reliability degree changes in a multi-level manner; and

FIG. 13 is a diagram illustrating a modification example in which a reliability degree changes in a continuous manner.

### EMBODIMENTS FOR CARRYING OUT INVENTION

The following explains embodiments for clarifying the contents of the present disclosure.

A. First Embodiment

A-1. Apparatus configuration according to first embodiment:

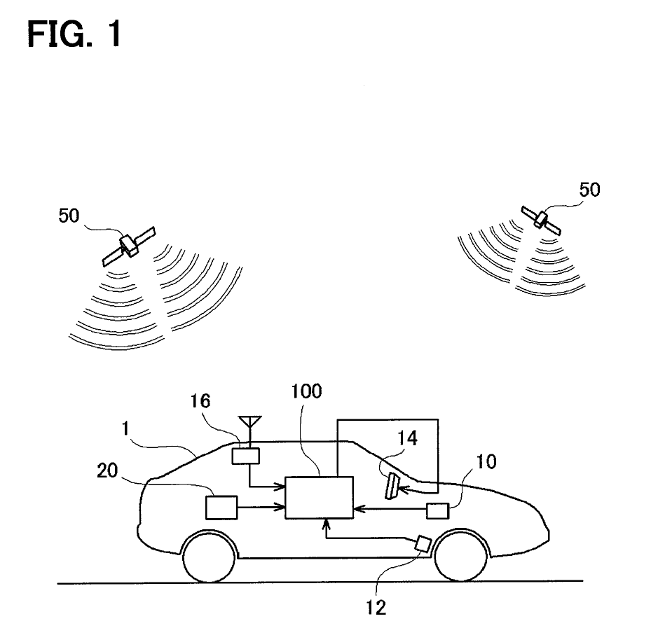

FIG. 1 illustrates schematically a configuration of a vehicle 1 mounted with a mobile-body position detecting apparatus 100 according to the first embodiment. Note that the vehicle 1 is also referred to as a host vehicle. As illustrated, the vehicle 1 is mounted with not only the mobile-body position detecting apparatus 100 but also a direction sensor 10, a distance sensor 12, a reception apparatus 16, a display apparatus 14, an external storage 20, etc.

The direction sensor 10 is a sensor used in order to detect a heading direction of the vehicle 1; the direction sensor 10 may adopt a geomagnetic sensor or a gyro sensor. The distance sensor 12 is a sensor used in order to detect a movement distance of the vehicle 1; the distance sensor 12 may adopt a speed sensor that generates a certain number of pulses following rotation of a tire. The reception apparatus 16 can measure a current position of the vehicle 1 by receiving positioning signals from several positioning satellites 50. Note that the positioning satellites 50 include GNSS satellites such as GPS Satellites. Further, the current position of the vehicle 1 measured based on positioning signals can be acquired as the information on so-called latitude and longitude, and, in addition, as the information on altitude (height position). Note that “information” may be used not only as an uncountable noun but also a countable noun; a plurality of informations is equivalent to a plurality of information items.

The display apparatus 14 is used in order to display a current position of the vehicle 1, and may adopt various display apparatuses such as a liquid crystal display. The external storage 20 stores the map information, which includes road shapes. A so-called navigation apparatus stores the map information which includes road shapes and may be adopted as the external storage 20. The vehicle 1 according to the present embodiment corresponds to a “mobile body.”

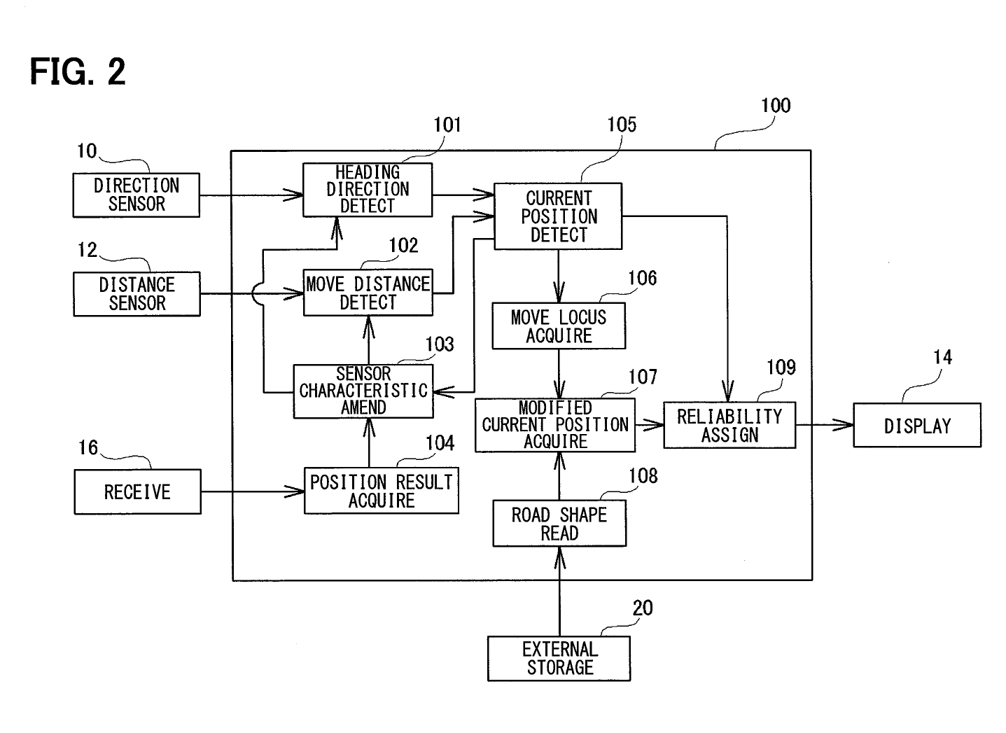

FIG. 2 illustrates an internal configuration of the mobile-body position detecting apparatus 100 according to the first embodiment. As illustrated, the mobile-body position detecting apparatus 100 according to the first embodiment includes a heading direction detection section 101, a movement distance detection section 102, a sensor characteristics amendment section 103, a positioning result acquisition section 104, a current position detection section 105, a movement locus generation section 106, a modified current position acquisition section 107, a road shape read-out section 108, and a reliability assignment section 109. The above “sections” are an abstract concept classifying an internal configuration of the mobile-body position detecting apparatus 100 for convenience by focusing on functions prepared for the mobile-body position detecting apparatus 100 detecting a current position of the vehicle 1. Therefore, the mobile-body position detecting apparatus 100 is not physically divided into those “sections.” Those “sections” can be achieved as a computer program executed by a CPU, as an electronic circuit containing an LSI and a memory, or as a combination of the foregoing. In addition, for example, a detection section may be also referred to as a detection module, a detection device, or a detector.

The heading direction detection section 101 receives an output from the direction sensor 10 and detects a heading direction of the vehicle 1. When the direction sensor 10 adopts a sensor of a type that outputs a direction itself like a geomagnetic sensor, the direction of the vehicle 1 is detected using an output of the direction sensor 10. In contrast, when the direction sensor 10 adopts a sensor of a type that outputs a change in direction like a gyro sensor, the direction of the vehicle 1 is detected by accumulating direction changes from an initial direction. This initial direction is acquired by reading out the direction of the vehicle 1 which has been stored from the time when the electric power source of the mobile-body position detecting apparatus 100 was turned off. Alternatively, the initial direction may be acquired by detecting a heading direction of the vehicle 1 from a positioning result using the positioning signals from the positioning satellites 50.

The movement distance detection section 102 receives an output from the distance sensor 12 and detects a movement distance of the vehicle 1. The heading direction of the vehicle 1 is detected by the heading direction detection section 101; thus, if the movement distance is known, to which direction and how much distance the vehicle 1 moved are known. In addition, although changing every moment, the heading direction of the vehicle 1 can be supposed to be constant for a short time. The current position detection section 105 thus acquires a heading direction and a movement distance of the vehicle 1 with each of predetermined short time intervals and accumulates the acquired heading directions and movement distances, thereby detecting a current position of the vehicle 1. The current position detected by the current position detection section 105 may be the information on so-called latitude and longitude, or may be the information on altitude (height position) and/or direction (current direction) that indicates a heading direction of the vehicle 1, in addition to the latitude and the longitude.

The positioning result acquisition section 104 acquires a positioning result from the reception apparatus 16. As mentioned above, in the present embodiment, the reception apparatus 16 measures the current position of the vehicle 1 by receiving the positioning signals from the several positioning satellites 50. The positioning result acquisition section 104 thus acquires a positioning result from the reception apparatus 16. Without limited to the above, the reception apparatus 16 outputs the positioning signals to the positioning result acquisition section 104; then, the positioning result acquisition section 104 may acquire a positioning result based on the received positioning signals.

The sensor characteristics amendment section 103 amends the sensor characteristics of the direction sensor 10 and/or the distance sensor 12, based on the positioning result of the vehicle 1 acquired by the positioning result acquisition section 104 and on the current position of the vehicle 1 acquired by the current position detection section 105. This processing is as follows. First, the outputs of the direction sensor 10 and the distance sensor 12 include errors. Therefore, such errors are accumulated in the current position of the vehicle 1 acquired by the current position detection section 105. Suppose that the output of the distance sensor 12 be a little shorter than an actual distance because of an error of a small value, for instance. As the distance becomes longer, the accumulated error becomes larger. The same applies to the output of the direction sensor 10. That is, when an error is included in the output of the direction sensor 10, the errors are accumulated in the current position of the vehicle 1 acquired by the current position detection section 105. In addition, if the current position of the vehicle 1 incudes a heading direction of the vehicle 1, a large error may appear also in the detected direction.

Thus, the sensor characteristics amendment section 103 compares the current position of the vehicle 1 (output of the current position detection section 105) acquired by accumulating the outputs of the direction sensor 10 and the distance sensor 12 with the positioning result of the vehicle 1 (output of the positioning result acquisition section 104) acquired from the positioning signals. Note that although the information on longitude and latitude may be used as the current position and positioning result of the vehicle 1 that are compared with each other, the information on altitude (height position) and/or on direction (current direction) that indicates a heading direction of the vehicle 1 may be used in addition to the information on latitude and longitude. When there is a large difference between them, the sensor characteristics of the direction sensor 10 and the distance sensor 12 are amended little by little. Note that since the sensor characteristics are amended little by little, the difference between (i) the current position of the vehicle 1 acquired by accumulating the sensor outputs and (ii) the positioning result is not necessarily solved promptly. Since the positioning result acquired from the positioning signals also includes a specific error, amending little by little is thus adopted for avoiding mistakenly amending the sensor characteristics under the influence of such a specific error.

The movement locus generation section 106 generates a movement locus of the vehicle 1 by accumulating the current positions acquired by the current position detection section 105, and stores the movement locus relative to a predetermined distance or a predetermined period of time. When the current position acquired by current position detection section 105 includes the information on altitude, a three-dimensional movement locus is stored. The road shape read-out section 108 reads out a road shape (and position of the road) from the map information stored in the external storage 20, and outputs the read one to the modified current position acquisition section 107.

The modified current position acquisition section 107 performs so-called map matching by verifying the movement locus of the vehicle 1 generated by the movement locus generation section 106 and the road shape acquired from the modified current position acquisition section 107, thereby acquiring the current position (modified current position) of the vehicle 1 that is acquired by modifying in consideration of a road shape. Note that the current position of the vehicle 1 acquired by amending the sensor characteristics is further modified in consideration of a road shape. This is because the sensor characteristics are first amended based on the positioning result, but errors are also included in the positioning result. Therefore, even if the sensor characteristics are amended based on the positioning result, a certain amount of error still remains in the current position acquired by the current position detection section 105. The error of the current position of the vehicle 1 is made smaller by modifying in consideration of a road shape.

In contrast, the current position in consideration of a road shape may be sometimes modified incorrectly. The reliability assignment section 109 acquires the modified current position from the modified current position acquisition section 107, and furthermore, the current position before being modified from the current position detection section 105, thereby comparing two with each other. Then, based on the comparison result, the reliability assignment section 109 assigns the modified current position with the information on reliability degree and outputs the modified current position assigned with the reliability degree to the display apparatus 14. The target for outputting the modified current position need not be limited to the display apparatus 14, but may be a control apparatus (unshown) that is mounted in the vehicle 1.

Such a configuration enables the determination as to whether the modified current position displayed as a current position in the display apparatus 14 can be relied on, or whether it should be regarded as a reference at most. Further, it may be determined whether the vehicle 1 can be controlled based on the modified current position. That is, when the modified current position acquired as a current position of the vehicle 1 may be relied on, the modified current position may be used to perform controls that automatically decelerates before entering a curve, or automatically accelerates after exiting from a curve. By contrast, when the modification current position should be regarded as a reference at most, the modified current position may not be used to perform controls that automatically decelerates before entering a curve, or automatically accelerates after exiting from a curve. The following explains a current position detecting process by the above-mentioned mobile-body position detecting apparatus 100 according to the first embodiment.

A-2. Current position detecting process according to first embodiment:

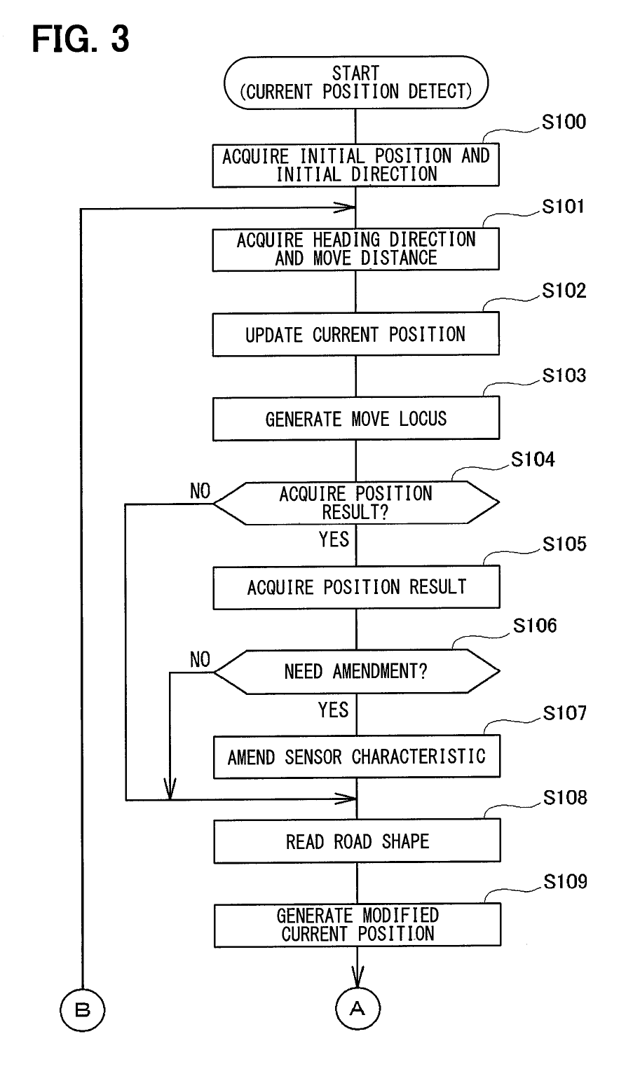

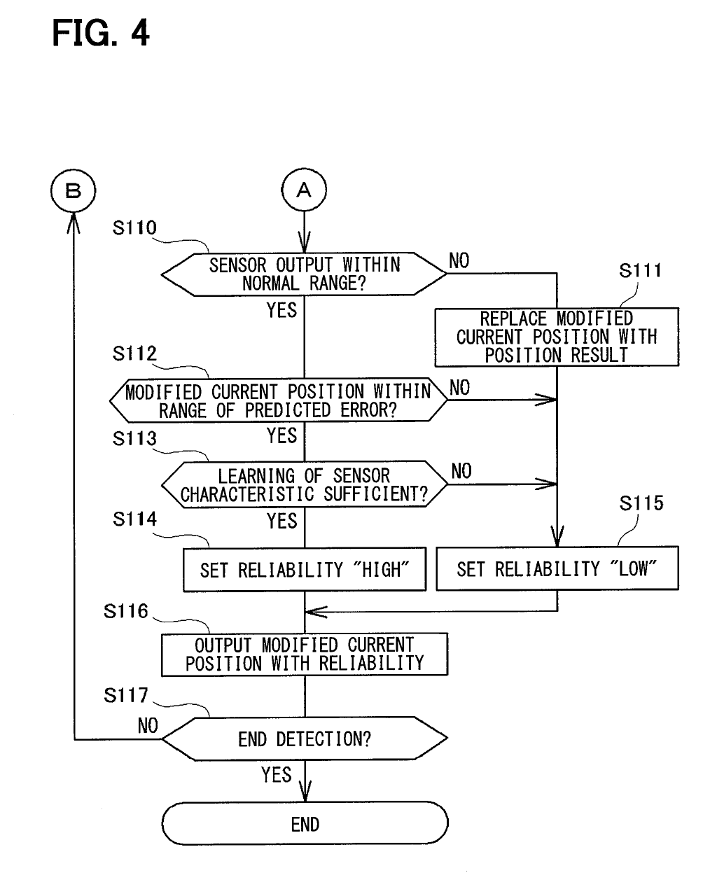

FIG. 3 and FIG. 4 illustrate a flowchart of a current position detecting process executed by the mobile-body position detecting apparatus 100 according to the first embodiment.

It is further noted that the described flowchart includes sections (also referred to as steps), which are represented, for instance, as S100. Further, each section can be divided into several sections while several sections can be combined into a single section. Each section may be referred to as a device, a module, or a specific name; for instance, a detection section may be referred to as a detection device, a detection module, or a detector. Further, each section can be achieved not only (i) as a software section in combination with a hardware unit (e.g., computer), but also (ii) as a hardware section (e.g., integrated circuit, hard-wired logic circuit), including or not including a function of a related apparatus. Further, the hardware section may be inside of a microcomputer.

As illustrated, the current position detecting process according to the first embodiment first acquires an initial position and an initial direction of the vehicle 1 (S100). In the present embodiment, when ending driving of the vehicle 1, the current position of the vehicle 1 and the current direction (orientation) of the vehicle 1 are stored in a memory (unshown); when starting driving, the current position and current direction which have been stored are read and regarded respectively as an initial position and an initial direction. Without being limited to the above, an initial position and an initial direction of the vehicle 1 may be detected based on the positioning results at several positions. That is, the positioning is made in each of several positions as the vehicle 1 travels; based on the positioning results in the several positions, a current position and a heading direction of the vehicle 1 are acquired and regarded as an an initial position and an initial direction, respectively. In addition, the current position of the vehicle 1 may include further the information on altitude (height position). Such a case stores a current position including an altitude at which the vehicle 1 is located and a direction (orientation) of the vehicle 1 when ending driving of the vehicle 1. Then when starting driving, the current position including the altitude and the direction which have been stored are read and regarded respectively as an initial position and an initial direction.

The heading direction of the vehicle 1 is acquired based on the output of the direction sensor 10, and the movement distance of the vehicle 1 is acquired based on the output of the distance sensor 12 (S101). By regarding the vehicle 1 as moving at the acquired heading direction by the acquired distance, the current position of the vehicle 1 is updated (S102). Furthermore, the movement locus of the vehicle 1 is generated by connecting the current position of the vehicle 1 acquired previously and the current position newly acquired (S103).

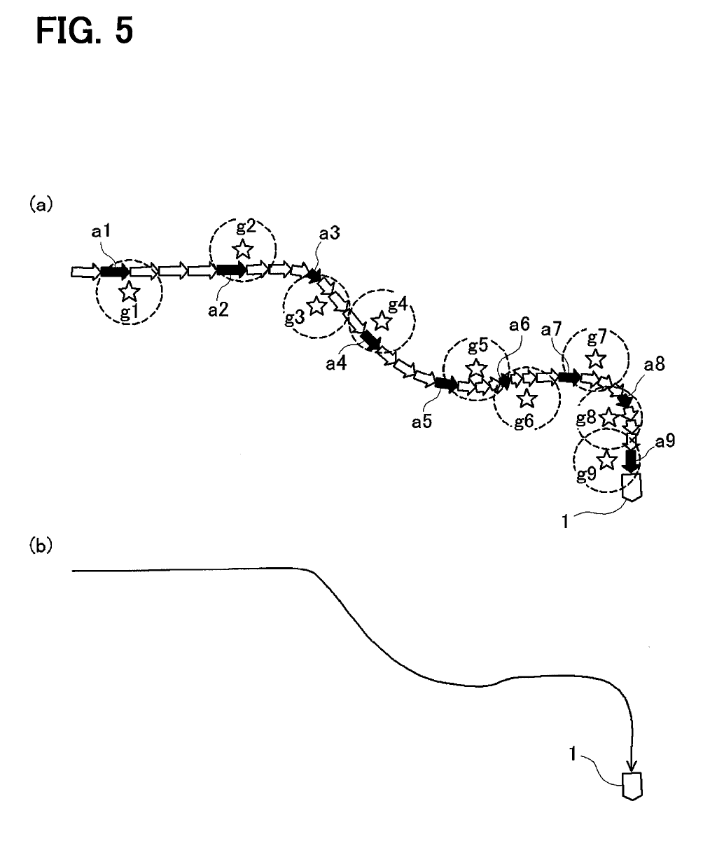

FIG. 5 illustrates a mode in which the current position of the vehicle 1 is updated to generate the movement locus. Each of arrows in (a) of FIG. 5 represents a heading direction and a movement distance of the vehicle 1 within a predetermined short period of time. The current position of the vehicle 1 is repeatedly updated one arrow-by-one arrow. Then connecting the updated current positions provides a movement locus illustrated in (b) of FIG. 5 as a solid line. Note that the movement locus thus acquired only needs to cover a predetermined distance (for example, 5 km) or a predetermined period of time (for example, 10 minutes); any previous movement locus that is preceding may be therefore deleted. In addition, an asterisk, a circle formed with broken lines, or a black-painted arrow, which are illustrated in (a) of FIG. 5, will be explained later.

Then, it is determined whether a positioning result of the vehicle 1 is acquired based on the positioning signals (S104). As mentioned above using FIG. 2, in the present embodiment, the reception apparatus 16 performs positioning and it is determined at S103 whether the positioning result is acquired with the reception apparatus 16. When the positioning result is acquired (S104: YES), the positioning result is acquired from the reception apparatus 16 (S105). It is then determined whether the sensor characteristics of the direction sensor 10 or the distance sensor 12 needs to be amended by comparing the acquired positioning result with the current position of the vehicle 1 acquired at S102 (S106). This determination is explained with reference to (a) of FIG. 5.

As explained, the current position of the vehicle 1 is updated one arrow-by-one arrow illustrated in (a) of FIG. 5. In addition, the positioning result based on the positioning signals is typically acquired each a predetermined period of time. In (a) of FIG. 5, the positioning results acquired based on the positioning signals are indicated using the asterisks. In addition, the respective positioning results are assigned with signs g1, g2, g3, g4, g5, g6, g7, g8, and g9, in order of being acquired. Those positioning results may be considered as corresponding to the current positions of the vehicle 1 at the time when the respective positioning results are acquired. Suppose that the current position is updated as the black-painted arrow a1 in (a) of FIG. 5 just before the positioning result g1 is acquired. The current position of the vehicle 1 corresponding to the positioning result g1 is regarded as the position indicated by the tip of the black-painted arrow a1. The same applies to the positioning result g2, the current position of the vehicle 1 corresponding to the positioning result g2 is regarded as the position indicated by the tip of the black-painted arrow a2. The same further applies to the following positioning results g3 to g9.

The time when the positioning result based on the positioning signals is acquired may correspond to the time in a middle of while the current position of the vehicle 1 is updated, or to the time just before the current position of the vehicle 1 is updated. In such a case, the current position of the vehicle 1 at the time when the positioning result is acquired may be predicted based on the current positions of the vehicle 1 at the time before and after the positioning result is acquired. Alternatively, the following may be adopted. First, a time difference is calculated between the time when the positioning result is acquired and the time when a current position of the vehicle 1 is updated just before the time when the positioning result is acquired, while a time difference is calculated between the time when the positioning result is acquired and the time when a current position of the vehicle 1 is updated just after the time when the positioning result is acquired. If the current position providing the time difference less than a threshold value is present, this current position is adopted as the current position of the vehicle 1 at the time when the positioning result is acquired. By contrast, if the current position providing the time difference less than a threshold value is not present, another current position may be presumed, based on the current positions just before and just after the time when the positioning result is acquired, as the current position of the vehicle 1 at the time when the positioning result is acquired.

As in (a) of FIG. 5, all the positioning results g1 to g9 indicated with the respective asterisks do not correspond to the current positions of the vehicle 1 indicated with the tip of the black-painted arrows a1 to a9. Note that the positioning signals also include errors and thus the positioning results include some errors. The magnitude of the error included in a positioning result may be predicted based on the kind of a positioning signal used for positioning, or on the number of positioning signals that are able to be used for positioning. Even if the current position of the vehicle 1 and the positioning result fail to accord with each other and exhibit a difference, as far as such a difference is within an error that is predicted (referred to as a predicted error), it is not determined that the current position of the vehicle 1 is deviated. In other words, as far as the current position of the vehicle 1 (or current direction) is within a range of a predicted error centering on the positioning result, there may be caused no big issue even if the current position of the vehicle 1 and the positioning result fail to accord with each other.

In (a) of FIG. 5, the broken-lined circle indicates a range of a predicted error centering on the positioning result. Although unshown, a range of a predicted error may be also considered with respect to the current direction indicating the heading direction of the vehicle 1. In an example in (a) of FIG. 5, all the black-painted arrows a1 to a9 have the current positions of the vehicle 1 indicating the tips of the arrows that are located within the range of the predicted errors illustrated in broken lines; thus, the current positions seem to be generally detected as being correct. This signifies that amending the sensor characteristics of the direction sensor 10 or the distance sensor 12 does not provide a significant improvement and thus it is determined that there is no necessity of amending by force. By contrast, if the current positions of the vehicle 1 are outside of the range of the predicted errors centering on the positioning results, the current positions seem to be deviated from the correct positions. It is thus determined that amending the sensor characteristics of the direction sensor 10 or the distance sensor 12 is needed.

At S106 of the current position detecting process in FIG. 3, it is determined whether to need the amendment of sensor characteristics, as mentioned above. That is, it is determined whether the current position acquired at S102 is within the range of the predicted error centering on the positioning result acquired at S105. As a result, when the current position acquired at S102 is not within the range of the predicted error, it is determined that the amendment of the sensor characteristics is necessary (S106: YES). By contrast, when it is within the range of the predicted error, it is determined that the amendment of the sensor characteristics is unnecessary (S106: NO). The above explanation is under an assumption that an error included in each positioning result is a predicted error. If the several positioning results are averaged, the magnitude of the predicted error can also be made smaller than the error included in each positioning result. Thus it may be determined whether the current position acquired at S102 is within the range of the predicted error acquired from the several positioning results and it may be determined whether the amendment of the sensor characteristics is necessary.

When it is determined that the amendment of the sensor characteristics is necessary (S106: YES), the sensor characteristics are amended in increments of a predetermined amount to move the current position acquired at S102 towards the positioning result acquired at S105 (S107). When the sensor characteristics are amended at S107, not only the sensor characteristics are amended but also the current position acquired at S102 may be amended to approach the positioning result acquired at S105 in increments of a predetermined amount.

In contrast, when it is determined that the amendment of the sensor characteristics is unnecessary (S106: NO), any sensor characteristics are not amended. In addition, when it is determined that the positioning result is not acquired at S104 (S104: NO), a sequence of processing from acquiring the positioning result up to amending the sensor characteristics (S105-S107) is omitted.

The road shapes within a predetermined range including the current position of the vehicle 1 are read out from the map information stored in the external storage 20 (S108). The movement locus of the vehicle 1 generated at S103 is verified with the read road shapes to thereby perform map matching that modifies the current position of the vehicle 1 to a current position that is supposed to be a correct one; thus, a current position that is modified (hereinafter, referred to as “modified current position”) is generated (S109).

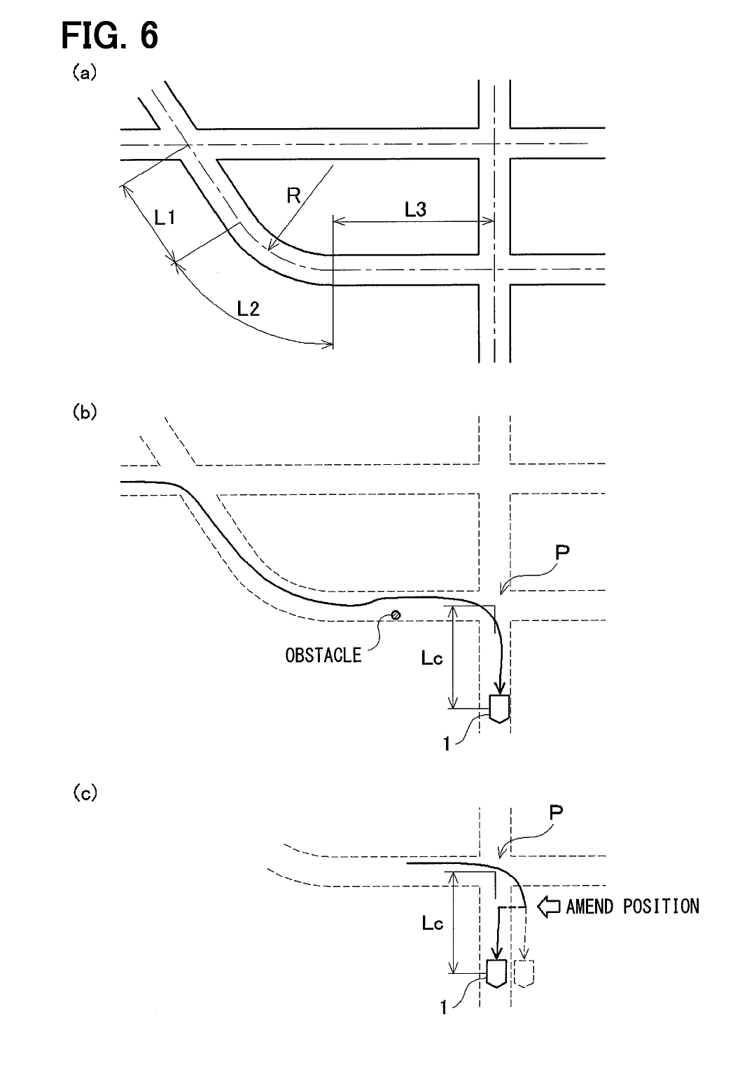

FIG. 6 indicates an outline of map matching. For example, suppose that the road shapes read out from the map information include a characteristic road shape that is illustrated in (a) of FIG. 6. This road shape is significantly similar to an overall shape of the movement locus of the vehicle 1, as illustrated in (b) of FIG. 5. Furthermore, as illustrated in (b) of FIG. 6, when the movement locus is superimposed on the road shape, the movement locus can be superimposed without being protruded from the road. In such a case, the current position of the vehicle 1 can be determined in a high accuracy such that the vehicle 1 is located at distance Lc from the intersection P after turning to the right at this intersection P illustrated in (b) of FIG. 6.

The vehicle 1 does not necessarily run the center of a road. In addition, each driver is supposed to drive a vehicle at an intersection or curve in a different manner. Furthermore, in order to avoid another vehicle or an obstacle, etc., on a road, the vehicle 1 may run a shoulder portion of the road. In such a case, when applying the movement locus of the vehicle 1 to a road shape, it may be applied to a deviated position or a deviated angle. When such a deviation arises, the subsequent movement locus of the vehicle 1 may exhibit an inconsistency. For example, in an example in (b) of FIG. 6, the vehicle 1 passes through the position largely deviated inward of the road at the intersection located first at the left end on the drawing. Therefore, when applying the movement locus of the vehicle 1 to the road shape, the movement locus is shifted and applied to the right-hand side a little on the drawing; thus, when the vehicle 1 turns to the right at the intersection P, the vehicle 1 appears as protruding from the road. Thus, in such a case, the map matching amends the position of the vehicle 1 to be drawn inside the road, as illustrated in (c) of FIG. 6. At S109 of the current position detecting process in FIG. 3, the above map matching is applied to the current position of the vehicle 1 acquired at S102 to thereby modify the current position and generate a modified current position.

Then, it is determined whether the output of the direction sensor 10 or the distance sensor 12 is within a normal range (S110 in FIG. 4). Failures such as a defect of a sensor itself or a disconnection of wires from a sensor cause the output from the sensor to be deviated from a normal range. It is thus determined whether such a failure arises. As a result, when it is determined that the output of the sensor is outside the normal range (S110: NO), it is supposed that a certain failure arises in the direction sensor 10 or the distance sensor 12 and the modified current position acquired based on the output of the sensor cannot be trusted. Then, in this case (S110: NO), the modified current position is replaced with the positioning result acquired at this time (S111), and then the modified current position is assigned with a reliability degree of “low” (S115).

By contrast, when it is determined that the sensor output is within the normal range (S110: YES), it is determined whether the modified current position acquired with the map matching is within a range of the predicted error centering on the current position of the vehicle 1 acquired at S102 (S112). As mentioned above, the predicted error is an error which arises based on an error included in the positioning signals. The magnitude of the predicted error may be predicted based on the kind of a positioning signal used for positioning, or on the number of positioning signals that are able to be used for positioning. In addition, instead of using the error included in each positioning result as a predicted error, an error, which is acquired as a smaller error by averaging the positioning results acquired multiple times, may be used as a predicted error.

Note that the predicted error is an error which arises based on an error included in the positioning signals; thus, the predicted error should be naturally set as centering on the position acquired with the positioning result. Regardless of this rationale, a predicted error is set at S112 as centering on the current position of the vehicle 1 acquired at S102, and it is then determined whether the modified current position acquired with the map matching is within the range of such a predicted error. This is based on the following reason.

First, measuring a position of the vehicle 1 need several positioning signals; thus the positioning result cannot be always acquired. By contrast, the current position of the vehicle 1 acquired by accumulating the outputs of the direction sensor 10 and the distance sensor 12 can always be acquired. Further, the sensor characteristics of the direction sensor 10 and the distance sensor 12 are amended such that the current position of the vehicle 1 acquired at S102 is located within the range of the predicted error of the positioning result acquired at S105, as explained using (a) of FIG. 5. Even if the positioning result is not acquired at a certain moment, it is thus supposed that the positioning result is present within the range of the predicted error centering on the current position of the vehicle 1 acquired at S102. At S112, the range of the predicted error centering on the current position of the vehicle 1 acquired at S102 is set as a range where a positioning result is acquirable.

As a result, when the modified current position is not within the range of the predicted error (S112: NO), the result of the map matching is supposed to be not proved by the positioning result based on the positioning signals and the modified current position is assigned with a reliability degree of “low” (S115). By contrast, when the modified current position is within the range of the predicted error (S112: YES), it is determined whether the learning of the sensor characteristics is sufficient enough (S113). That is, as mentioned above, when the position detecting process determines that the amendment of the sensor characteristics is necessary (S106: YES in FIG. 3), the sensor characteristics (for example, sensitivity of the direction sensor 10, or a distance per one pulse of the distance sensor 12) is amended in increments of a predetermined amount (S107). A large amendment made at once may pose an excessive amendment; an amount of the amendment one time is reduced to make the sensor characteristics close to a proper one little by little. This may, by contrast, increase a possibility that the sensor characteristics still fails to reach a proper one if the number of amendments is not sufficiently large. Thus, at S113 in FIG. 4, it is determined whether the number of amendments up to that time reaches the sufficient number of amendments. When reaching the sufficient number, the learning of the sensor characteristics is sufficient enough (S113: YES). When not reaching the sufficient number, the learning of the sensor characteristics is not sufficient enough (S113: NO).

The above explains that whether the learning of the sensor characteristics is sufficient or not is determined based on the number of amendments of the sensor characteristics. Alternatively, such determination may be performed as follows. First, as mentioned above at S106, the necessity of determining whether the amendment of the sensor characteristics is necessary is determined based on whether the difference between the current position of the vehicle 1 acquired at S102 and the positioning result acquired at S105 is within the range of the predicted error. If such a difference is significantly smaller than the predicted error, the learning of the sensor characteristics may be determined to be sufficient enough.

When it is determined at S113 that the learning of the sensor characteristics is not sufficient enough (S113: NO), the modified current position is assigned with a reliability degree of “low” (S115). By contrast, when it is determined that the learning of the sensor characteristics is sufficient enough (S113: YES), the sensor output is determined to be in the normal range (S110: YES). The modified current position is further determined to be within the range of the predicted error (S112: YES); the learning of the sensor characteristics is determined to be sufficient enough (S113: YES). Such a case allows a supposition that the result of the map matching is proved by the positioning result based on the positioning signals. The modified current position is thus assigned with a reliability degree of “high” (S114).

In this way, the modified current position acquired with the map matching is assigned with the reliability degree (S114, S115). Then the modified current position, which is assigned with the reliability degree, is outputted to an external source (i.e., the display apparatus 14) (S116); it is determined whether the detection of the current position is ended (S117). When being not ended (S117: NO), the processing returns to S101 in FIG. 3 to acquire the heading direction and movement distance of the vehicle 1 and then perform a series of the processing (S102 to S117) mentioned above. By contrast, when the detection of the current position is ended (S117: YES), the current position detecting process according to the first embodiment in FIG. 3 and FIG. 4 is ended.

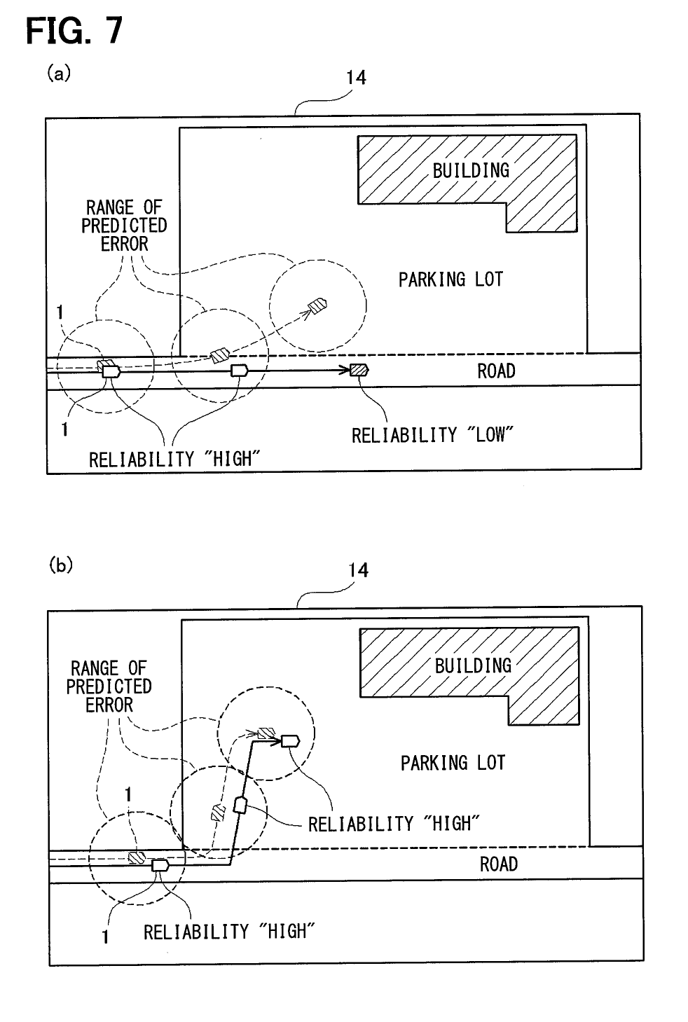

As explained above, the reliability degree can be assigned to the current position of the vehicle 1 acquired with the map matching. Such a configuration allows the determination whether the acquired current position (or direction) may be relied on, or the acquired one may be regarded as a reference at most. This can use more effectively the current position acquired with the map matching. Suppose that the vehicle 1 running a road is about to enter a parking lot in a roadside along the road, for example. FIG. 7 illustrates the display apparatus 14 displaying on a screen a position (i.e., a modified current position) of the vehicle 1 acquired with the map matching. The vehicle 1 and movement locus which are illustrated as thick solid lines in the drawing represent the position (i.e., modified current position generated at S109 in FIG. 3) and movement locus of the vehicle 1, which are acquired with the map matching. Further, the vehicle 1 and movement locus which are illustrated as thin broken lines in the drawing represent the current position of the vehicle 1 acquired by accumulating the outputs of the direction sensor 10 and the distance sensor 12 (i.e., current position acquired at S102 in FIG. 3) and the movement locus (i.e., movement locus generated at S103). The current position acquired at S102 will be referred to as “current position with the dead reckoning navigation.” Furthermore, the circle illustrated with thin broken lines in the drawing represents a range of the predicted error centering on the current position with the dead reckoning navigation.

As illustrated in (a) of FIG. 7, when the vehicle 1 enters aslant the parking lot, the vehicle 1 separates from the road little by little. In contrast, the position of the vehicle 1 is drawn towards the road due to the map matching. This may possibly cause the vehicle 1 to be displayed as still running on the road, regardless of entering the parking lot in fact. In such a case, when the current position (i.e., modified current position) of the vehicle 1 acquired with the map matching comes to be outside the range of the predicted error centering on the current position with the dead reckoning navigation, the vehicle 1 currently displayed on the screen of the display apparatus 14 changes in the display mode from the reliability degree of “high” to the reliability of “low.” This change enables the driver to recognize that the vehicle is not running on the road in fact (i.e., deviates from the road).

In addition, in the example illustrated in (b) of FIG. 7, the vehicle 1 enters the parking lot by changing clearly the heading direction from when running on the road. This prevents the map matching from drawing the position of the vehicle 1 into the road; as a result, the display apparatus 14 displays the vehicle 1 on the screen as running outside the road. In such a case, the current position (i.e., modified current position) of the vehicle 1 acquired with the map matching is within the range of the predicted error centering on the current position with the dead reckoning navigation. The display on the screen of the display apparatus 14 remains in the reliability degree of “high.” This enables the driver to trust the screen on which the position of the vehicle 1 is displayed as separating from the road and recognize that the vehicle 1 runs outside the road in fact.

B. Second Embodiment

B-1. Apparatus configuration according to second embodiment:

The first embodiment mentioned above explains that the reliability degree is assigned to the modified current position of the vehicle 1 acquired with the map matching based on the predicted error that arises from errors of the positioning signals. Assigning the reliability degree can utilize further the modified current position of the vehicle 1 acquired with the map matching. Techniques to detect a current position of the vehicle 1 include other techniques of various kinds other than the map matching; the current positions detected such other techniques may use the above mentioned configuration. The following explains such another technique as a second embodiment.

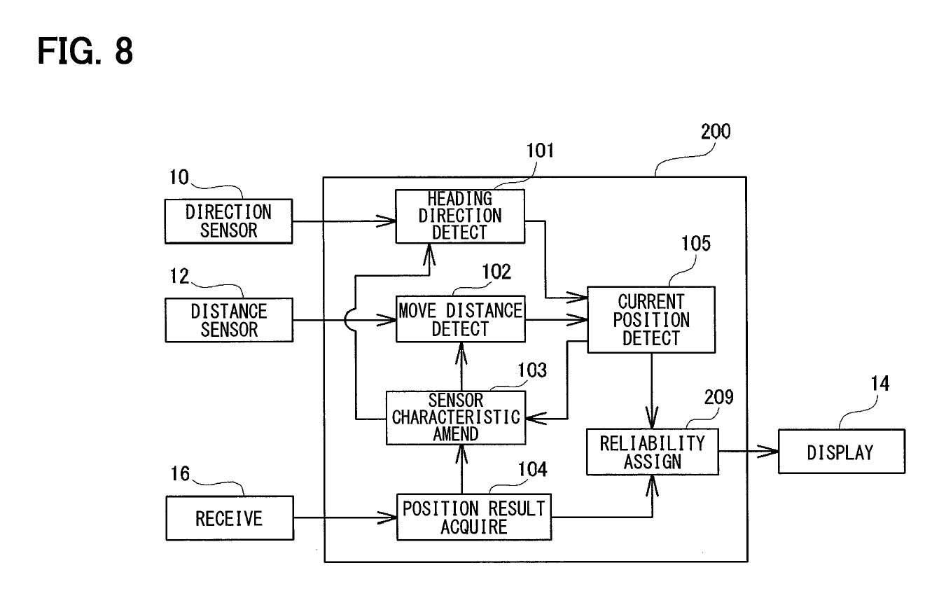

FIG. 8 illustrates an internal configuration of a mobile-body position detecting apparatus 200 according to a second embodiment. As illustrated, the mobile-body position detecting apparatus 200 according to the second embodiment includes a heading direction detection section 101, a movement distance detection section 102, a sensor characteristics amendment section 103, a positioning result acquisition section 104, a current position detection section 105, and a reliability assignment section 209. Among them, the heading direction detection section 101, the movement distance detection section 102, the sensor characteristics amendment section 103, the positioning result acquisition section 104, and the current position detection section 105 are the same as those of the mobile-body position detecting apparatus 100 according to the first embodiment mentioned above; thus, their explanation is omitted.

The reliability assignment section 209 acquires a current position of the vehicle 1 from the current position detection section 105, and acquires a positioning result of the vehicle 1 from the positioning result acquisition section 104, thereby comparing them. The reliability degree is assigned to the current position from the current position detection section 105 based on whether the current position of the vehicle 1 acquired by the current position detection section 105 is proved, as being within the range of the error, by the positioning result acquired by the positioning result acquisition section 104. The current position assigned with the reliability degree is then outputted to an external source (e.g., the display apparatus 14). This permits the determination as to whether the current position (or direction) displayed on the display apparatus 14 as a current position of the vehicle 1 may be relied on or regarded as a reference at most. The current position of the vehicle 1 displayed in the display apparatus 14 can be further utilized for driving.

B-2. Current position detecting process according to second embodiment:

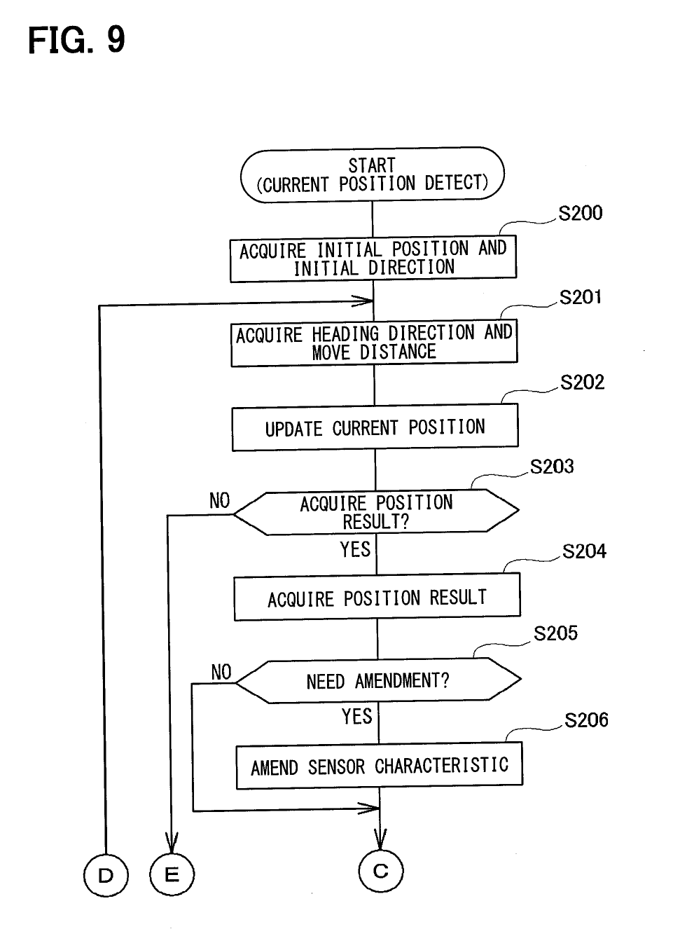

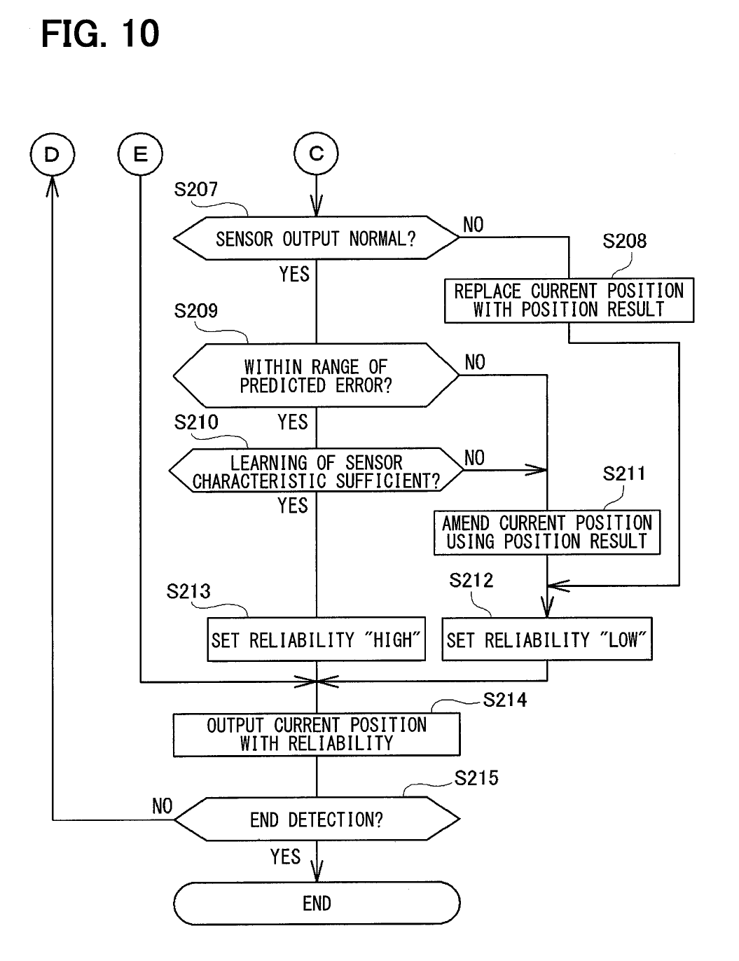

FIG. 9 and FIG. 10 illustrate a flowchart of a current position detecting process executed by the mobile-body position detecting apparatus 200 according to the second embodiment. As illustrated, in the current position detecting processing of the second embodiment, like the current position detecting process according to the first embodiment mentioned above, an initial position and an initial direction of the vehicle 1 are acquired first (S200). Then, a heading direction of the vehicle 1 is acquired based on the output of the direction sensor 10, and a movement distance of the vehicle 1 is acquired based on the output of the distance sensor 12 (S201). By regarding the vehicle 1 as moving at the acquired heading direction by the acquired distance, the current position of the vehicle 1 is updated (S202).

Then, it is determined whether a positioning result of the vehicle 1 is acquired based on the positioning signals (S203). In the second embodiment, like the first embodiment mentioned above, the reception apparatus 16 performs positioning and it is determined whether the positioning result is acquired with the reception apparatus 16. As a result, when the positioning result is acquired (S203: YES), the positioning result is acquired from the reception apparatus 16 (S204). It is then determined whether the sensor characteristics of the direction sensor 10 or the distance sensor 12 need to be amended (S205). This determination is the same as that in the first embodiment explained above using (a) of FIG. 5; the explanation is omitted.

When it is determined that the amendment of the sensor characteristics is necessary (S205: YES), the sensor characteristics are amended in increments of a predetermined amount to move the current position acquired at S202 towards the positioning result acquired at S204 (S206). By contrast, when it is determined that the amendment of sensor characteristics is unnecessary (S205: NO), the amendment of the sensor characteristics is not performed.

Then, it is determined whether the output of the direction sensor 10 or the distance sensor 12 is within a normal range (S207 in FIG. 10). When it is determined that the sensor output is not within the normal range (S207: NO), it is supposed that failures such as a defect of a sensor itself or a disconnection of wires from a sensor arises and the current position is thus not trusted. In this case (S207: NO), the current position is replaced with the positioning result acquired at this time (S208), and the reliability degree assigned to the current position is set to “low” (S212).

By contrast, when it is determined that the sensor output is within the normal range (S207: YES), whether the difference between the current position of the vehicle 1 acquired at S202 and the positioning result acquired at S204 is within the range of the predicted error of the positioning result (S209). As mentioned above, the predicted error is an error which arises based on an error included in the positioning signals. In addition, instead of using the error included in each positioning result as a predicted error, an error, which is acquired as a smaller error by averaging the positioning results acquired multiple times, may be used as a predicted error.

As a result, when the current position with the dead reckoning navigation is not within the range of the predicted error (S209: NO), the result of the dead reckoning navigation is supposed to be not proved by the positioning result based on the positioning signals. In this case, the current position (current position acquired at S202) acquired with the dead reckoning navigation is amended to be close to the positioning result (positioning result acquired at S204) based on the positioning signals (S211). The current position is then assigned with a reliability degree of “low” (S212).

By contrast, when the difference between the current position of the vehicle 1 and the positioning result is within the range of the predicted error (S209: YES), it is determined whether the learning of the sensor characteristics is sufficient enough (S210). Herein, if the number of amendments of the sensor characteristics up to this time reaches the sufficient number, it is determined that the learning of the sensor characteristics is sufficient enough (S210: YES). When not reaching the sufficient number, the learning of the sensor characteristics is not sufficient enough (S210: NO). The current position of the vehicle 1 acquired at S202 and the positioning result acquired at S204 may be compared to find a difference between them. If such a difference is significantly smaller than the predicted error, the learning of the sensor characteristics may be naturally determined to be sufficient enough.

When it is determined at S210 that the learning of the sensor characteristics is not sufficient enough (S210: NO), the current position is amended using the positioning result (S211). The current position is then assigned with a reliability degree of “low” (S212). By contrast, when it is determined that the learning of the sensor characteristics is sufficient enough (S210: YES), the sensor output is determined to be in the normal range (S207: YES). The current position is further determined to be within the range of the predicted error (S209: YES); the learning of the sensor characteristics is determined to be sufficiently progressed (S210: YES). In such a case, the current position of the vehicle 1 acquired by accumulating the outputs of the direction sensor 10 and the distance sensor 12 (i.e., current position acquired with the dead reckoning navigation) is supposed to be proved by the positioning result based on the positioning signals. The current position is thus assigned with a reliability degree of “high” (S213).

In this way, the reliability degree is assigned to the current position with the dead reckoning navigation (S213, S212). Then the current position, which is assigned with the reliability degree, is outputted to an external source (i.e., the display apparatus 14) (S214); it is determined whether the detection of the current position is ended (S215). When being not ended (S215: NO), the processing returns to S201 in FIG. 9 to acquire the heading direction and movement distance of the vehicle 1 and then perform a series of the processing (S202 to S215) mentioned above. By contrast, when the detection of the current position is ended (S215: YES), the current position detecting process according to the second embodiment in FIG. 9 and FIG. 10 is ended.

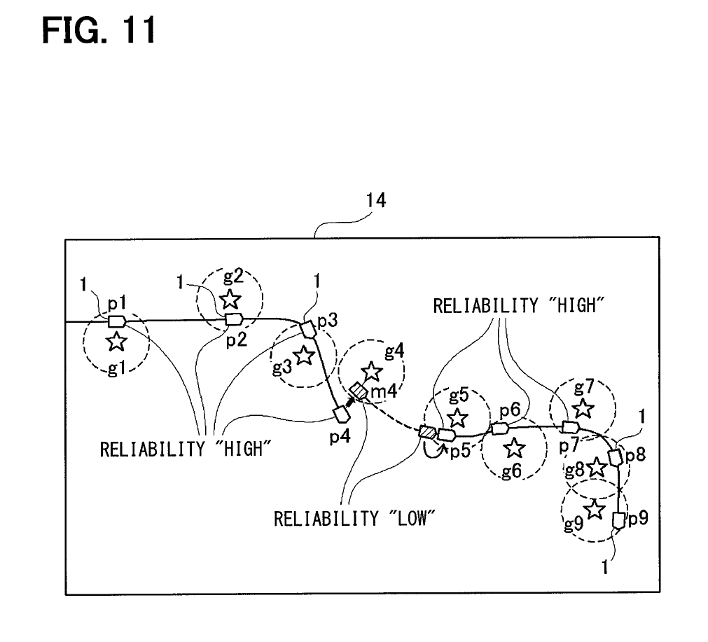

FIG. 11 illustrates the display apparatus 14 displaying on the screen the current position acquired in the current position detecting process according to the second embodiment. In the drawing, the positioning results acquired based on the positioning signals are indicated using the asterisks. In addition, the respective positioning results are assigned with signs g1, g2, g3, g4, g5, g6, g7, g8, and g9, in order of being acquired. Furthermore, the circle indicated with broken lines represents the range of the predicted error of each positioning result. In addition, the current position of the vehicle 1 detected with the dead reckoning navigation can be compared against the positioning results, like the first embodiment mentioned above. FIG. 11 illustrates those as p1, p2, p3, p4, p5, p6, p7, p8, and p9.

For example, the current positions p1, p2, p3 corresponding to the positioning results g1, g2, and g3 are present within the range of the predicted error. Therefore, the current positions acquired with the dead reckoning navigation are supposed to be proved by the positioning results based on the positioning signals; thus the reliability degree of each current position is determined to be high.

By contrast, the current position p4 based on the dead reckoning navigation at the time of acquiring the positioning result g4 is outside the range of the predicted error of the positioning result g4. Therefore, the current position acquired with the dead reckoning navigation is supposed to be not proved by the positioning results based on the positioning signals; thus the reliability degree of the current position is determined to be low. Then, at the time when the positioning result g4 is acquired, the display mode of the current position p4 of the vehicle 1 is changed from the reliability degree of “high” to the reliability degree of “low.” Furthermore, after the current position p4 is amended as the position m4 put close to the position of the positioning result g4, the outputs of the direction sensor 10 and the distance sensor 12 are accumulated from the amended position m4 so as to thereby continue to detect the current position with the dead reckoning navigation.

Then, the current position p5 with the dead reckoning navigation at the time of acquiring the positioning result g5 is present within the range of the predicted error of the positioning result g5. The current position with the dead reckoning navigation is thus supposed to be proved by the positioning result based on the positioning signals; the display mode of the current position is returned from the reliability degree of “low” to the reliability degree of “high.” This permits the determination as to whether the current position (or direction) of the vehicle 1 displayed on the screen in the display apparatus 14 may be relied on or regarded as a reference at most. In the example as in FIG. 11, although the positions of the vehicle 1 in between m4 and p5 should be regarded as a reference at most, other positions displayed on the screen may be determined to be trusted. This enables the detection result of the current position of the vehicle 1 to be utilized much more effectively.

C. Modification examples:

In the first embodiment mentioned above, the reliability degree assigned to the modified current position is explained as either “high” or “low.” In the second embodiment mentioned above, the reliability degree assigned to the current position is explained as either “high” or “low.” However, there is no need of the reliability degree to be two levels of “high” or “low.” The reliability degree may be assigned as a multi-level manner not smaller than three levels; furthermore, the reliability degree may be assigned as being changed continuously.

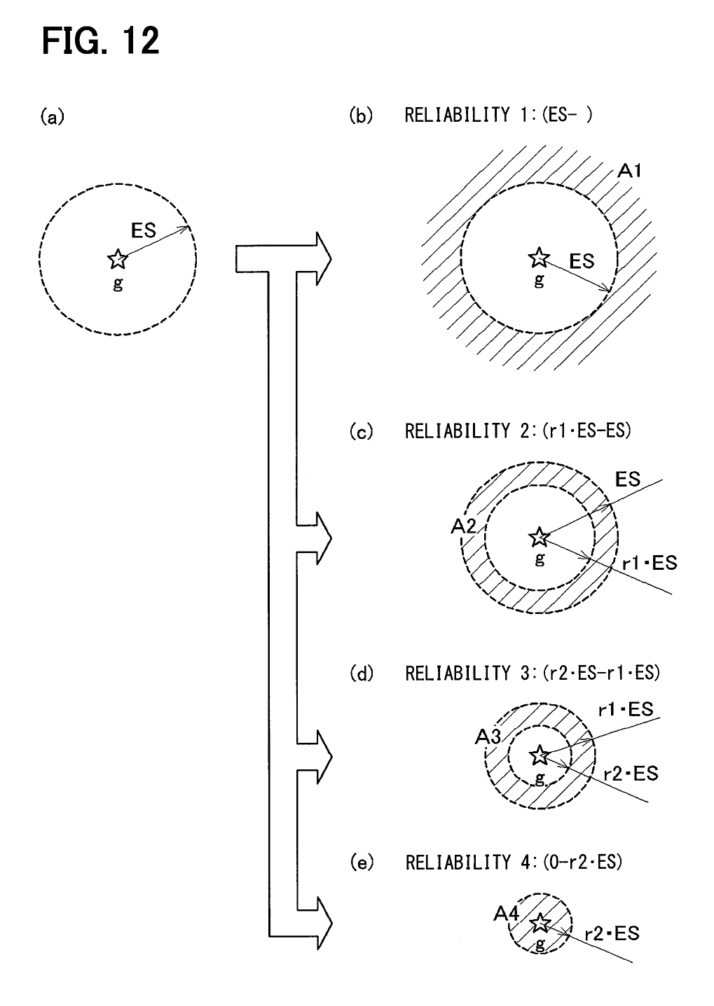

FIG. 12 illustrates a method of assigning the reliability degree in a multi-level manner. For example, as illustrated in (a) of FIG. 12, suppose that the magnitude of the predicted error is defined as a distance ES with respect to the positioning result g. In such a case, a region A1 is prepared as having a distance from the positioning result g being larger than the distance ES, as in (b) of FIG. 12. A region A2 is prepared as having a distance from the positioning result g being larger than a distance ES multiplied by r1 (r1<1) but not larger than the distance ES, as in (c) of FIG. 12. A region A3 is prepared as having a distance from the positioning result g being larger than a distance ES multiplied by r2 (r2<r1<1) but not larger than the distance ES multiplied by r1, as in (d) of FIG. 12. A region A4 is prepared as having a distance from the positioning result g being not larger than the distance ES multiplied by r2, as in (e) of FIG. 12.

If in the first embodiment, the reliability degree assigned to the modified current position is determined by which region the modified current position of the vehicle 1 is present. That is, when the modified current position is present in the region A1, the reliability degree 1 of the lowest reliability degree is determined; when the modified current position is present in the region A2, the reliability degree 2 higher than the reliability degree 1. Further, when the modified current position is present in the region A3, the reliability degree 3 higher than the reliability degree 2; when the modified current position is present in the region A4, the reliability degree 4 higher than the reliability degree 3. If in the second embodiment, the reliability degree assigned to the current position is determined by which region the current position of the vehicle 1 is present. This can set the reliability degrees of four levels according to the differences between the modified current position (or current position) of the vehicle 1 and the positioning result. As a matter of course, the number of levels of reliability degrees may set to have the larger number of levels without being limited to four levels.

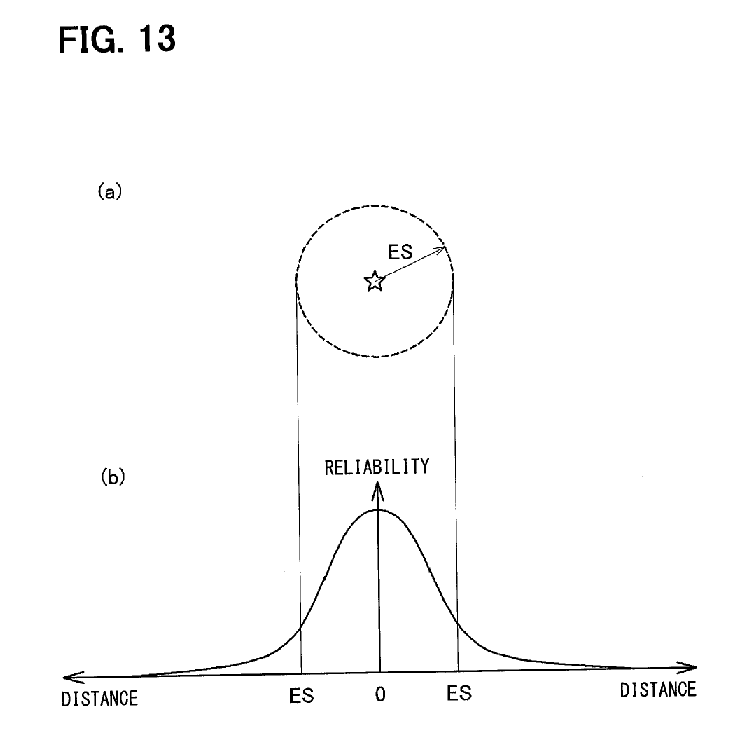

Alternatively, as exemplified in FIG. 13, the reliability degree may be assigned to change continuously. For example, as illustrated in (a) of FIG. 13, suppose that the magnitude of the predicted error is defined as a distance ES with respect to the positioning result g. As in (b) of FIG. 13, the reliability degree is assumed to be assigned using a normal distribution whose standard deviation is the distance ES. This can assign the reliability degree so as to change continuously, depending on the distance between the modified current position of the vehicle 1 and the positioning result in the first embodiment, or depending on the distance of the current position of the vehicle 1 and the positioning result in the second embodiment, for instance.

Although the present disclosure is described based on the embodiments, it is understood that the present disclosure does not need to be limited to the embodiments or their configurations. The present disclosure also includes various modification examples and modifications within a scope of an equivalent. In addition, various combinations or embodiments, and other combinations or embodiments which contain only a single element, more than one element, or less than it may be included within a scope or concept of the present disclosure.

For example, the embodiments and modification example mentioned above explain that the usage of the reliability degree assigned to the detection result of the current position of the vehicle 1 is to provide the driver by changing the display mode of the vehicle 1 on the screen in the display apparatus 14. However, without limited to providing the driver, it may be utilized for controls such as driving assistance. That is, the detection result of the current position assigned with the high reliability degree may be utilized for an advanced driving assistance to which a conventional detection result has not been applied to.

What is claimed is:

1. A mobile-body position detecting apparatus mounted in a mobile body to detect a current position of the mobile body, the mobile body including
a direction sensor that detects a heading direction,
a distance sensor that detects a movement distance, and
a reception apparatus that receives positioning signals from positioning satellites,
the mobile-body position detecting apparatus comprising:
a current position detection section that detects a current position of the mobile body by accumulating the heading direction and the movement distance;
a positioning result acquisition section that acquires a positioning result of the current position of the mobile body based on the positioning signals received from the positioning satellites;
a sensor characteristics amendment section that amends a characteristic of at least either the direction sensor or the distance sensor by comparing a detection result of the current position acquired by the current position detection section with the positioning result of the current position acquired by the positioning result acquisition section;
a movement locus generation section that generates a movement locus of the mobile body by accumulating the detection result of the current position acquired by the current position detection section;
a road shape read-out section that reads out a road shape from map information that is stored previously;
a modified current position acquisition section that acquires a modified current position that is acquired by modifying the current position of the mobile body through verifying the movement locus with the road shape; and
a reliability assignment section that assigns a reliability degree to the modified current position based on a difference between the modified current position and the current position detected by the current position detection section.

2. The mobile-body position detecting apparatus according to claim 1, wherein:
the current position detection section is a detection section that detects the current position including a height position of the mobile body; and
the positioning result acquisition section is an acquisition section that acquires the positioning result of the current position including a height position of the mobile body.

3. The mobile-body position detecting apparatus according to claim 1, wherein
the current position detection section is a detection section that detects the current position including a current direction that indicates a heading direction of the mobile body.

4. The mobile-body position detecting apparatus according to claim 1, wherein
the reliability assignment section is an assignment section that assigns the reliability degree to the modified current position by comparing the difference with a prediction error, the prediction error arising, in the detection result of the current position detection section, from an error included in the positioning signals.

5.-9. (canceled)

10. A mobile-body position detecting method applied to a mobile body to detect a current position of the mobile body, the mobile body including
a direction sensor that detects a heading direction,
a distance sensor that detects a movement distance, and
a reception apparatus that receives positioning signals from positioning satellites,
the mobile-body position detecting method comprising:
a current position detector that detects a current position of the mobile body by accumulating the heading direction and the movement distance;
a positioning result acquirer that acquires a positioning result of the current position of the mobile body based on the positioning signals received from the positioning satellites;
a sensor characteristics amender that amends a characteristics of at least either the direction sensor or the distance sensor by comparing the detection result of the current position in the current position detector with the positioning result of the current position in the positioning result acquirer;
a movement locus generator that generates a movement locus of the mobile body by accumulating a detection result of the current position in the current position detector;
a road shape reader that reads out a road shape from map information that is stored previously;
a modified current position acquirer that acquires a modified current position that is acquired by modifying the current position of the mobile body through verifying the movement locus with the road shape; and
a reliability assigner that assigns a reliability degree to the modified current position based on a difference between the modified current position and the current position detected in the current position detector.

11. (canceled)
